(19) United States
(12) Patent Application Publication
(10) Pub. No.: US 2014/0329928 A1
(43) Pub. Date: Nov. 6, 2014

(54) PHOTOACTIVATED, PRECIOUS METAL CATALYSTS IN CONDENSATION-CURE SILICONE SYSTEMS

(71) Applicant: 3M INNOVATIVE PROPERTIES COMPANY, St. Paul, MN (US)

(72) Inventors: Jitendra S. Rathore, Woodbury, MN (US); Maria A. Appeaning, St. Paul, MN (US); Larry D. Boardman, Woodbury, MN (US)

(21) Appl. No.: 14/366,158

(22) PCT Filed: Dec. 20, 2012
(86) PCT No.: PCT/US2012/070805

§ 371 Date: Jun. 17, 2014

Related U.S. Application Data
(60) Provisional application No. 61/578,031, filed on Dec. 20, 2011.

(51) Int. Cl. C08G 77/38; C08J 3/28

(52) U.S. Cl. CPC C08G 77/38; C08J 3/28
USPC 522/146; 525/475

(57) ABSTRACT

Photoactivated, precious metal catalysts in combination with condensation-cure silicone systems are described. Curable compositions including hydroxyl-functional polyorganosiloxanes, hydride-functional silanes, and a catalyst comprising a precious metal complexed with an actinic-radiation-displaceable ligand are described. Methods of curing such compositions and the resulting cured compositions are also discussed.

### FIELD

The present disclosure relates to photoactivated, precious metal catalysts. More specifically, photoactivated, precious metal catalysts in combination with condensation-cure silicone systems are described.

### SUMMARY

Briefly, in one aspect, the present disclosure provides a curable composition comprising a hydroxyl-functional polyorganosiloxane, a hydride-functional silane comprising at least two silicon-bonded hydrogen atoms; and a catalyst comprising a precious metal complexed with an actinic-radiation-displaceable ligand. In some embodiments, the ligand comprises at least one of a beta-diketonate (β-diketonate), an eta-bonded cyclopentadienyl (η-cyclopentadienyl), and a sigma-bonded aryl (σ-aryl).

In some embodiments, the ligand is a beta-diketonate. In some embodiments, the beta-diketonate is selected from the group consisting of 2,4-pentanedionates; 2,4-hexanedionates; 2,4-heptanedionates; 3,5-heptanedionates; 1-phenyl-1,3-heptanedionate; and 1,3-diphenyl-1,3-propanedionate. In some embodiments, the catalyst is M-2,4-pentanedionate, where M is a precious metal such as platinum or palladium.

In some embodiments, the catalyst is an (η-cyclopentadienyl)tri(σ-aliphatic)-M complex, wherein M is a precious metal. In some embodiments, the (η-cyclopentadienyl) tri(σ-aliphatic)-M complex has the formula CpM-(R1)₃; wherein Cp represents the cyclopentadienyl group that is eta-bonded to the precious metal, and each R1 group is, independently, is a saturated aliphatic group having one to eighteen carbon atoms sigma bonded to the precious metal. In some embodiments, the catalyst has the formula COD-M-(Aryl)₂; wherein COD is the cyclooctadienyl group, M is a precious metal, and Aryl represents an aryl group. In some embodiments, the aryl group is a phenyl group substituted with one or more of an akyl group, an alkoxy group, and a halogen. In some embodiments, at least one of the alkyl groups or alkoxy groups is perfluorinated.

In some embodiments, the curable comprises 5 to 200 ppm, e.g., 10-50 ppm, of the precious metal based on the total weight of the hydroxyl-functional polyorganosiloxane and the hydride-functional silane.

In another aspect, the present disclosure provides a method of preparing a cured composition comprising, exposing the curable compositions of the present disclosure to actinic radiation, and condensation-curing the hydroxyl-functional polyorganosiloxane with the hydride-functional silane to form the cured composition. In some embodiments, the actinic radiation has a wavelength of 200 to 800 nm, inclusive, e.g., 200 to 400 nm, inclusive.

In yet another aspect, the present disclosure provides materials prepared curing the compositions of the present disclosure. In some embodiments, the cured composition is a release material. In some embodiments, the cured composition is a room temperature vulcanite.

The above summary of the present disclosure is not intended to describe each embodiment of the present invention. The details of one or more embodiments of the invention are also set forth in the description below. Other features, objects, and advantages of the invention will be apparent from the description and from the claims.

### DETAILED DESCRIPTION

Curable silicone materials are useful in a variety of applications. For example, some curable silicone systems can be used to prepare release materials, e.g., release coatings for adhesives including, e.g., pressure sensitive adhesives. Other useful curable silicone systems include room temperature vulcanizable (“RTV”) materials. Silicone systems have been prepared using a variety of approaches, including addition-cure and condensation-cure chemistries.

Addition-cure refers to a system where curing is achieved through the addition of Si—H across a pi (π) bond, i.e., hydrosilation. One advantage of addition-cure systems is that precious metal catalysts (e.g., platinum catalysts) are exceptionally efficient, e.g., even with low parts per million (ppm) of platinum, the hydrosilylation reaction can occur rapidly without producing by-products. Both thermal-cure and radiation-cure, precious metal catalysts have been used in addition-cure (i.e., hydrosilation) silicone systems.

Condensation cure refers to a system where curing is achieved through the reaction of Si—OH and Si—H groups leading to the formation of Si—O—Si linkages and hydrogen gas. Exemplary condensation-cure silicone systems include those comprising hydroxyl-functional polyorganosiloxane(s) and hydride-functional silane(s). Typically, condensation-cure silicone systems have been cured with tin catalysts. Although condensation-cure systems offer some advantages, there is a desire to eliminate the use of tin. In addition, some condensation-cure systems, including, e.g., RTV systems, rely on the presence of water (e.g., humidity) for curing. Such systems are inherently less stable, and improvements in shelf-life and curing consistency are desired.

Surprisingly, the present inventors discovered that photoactivated precious metal catalysts—previously thought suitable only for addition-cure (hydrosilation) systems—are effective in condensation-cure silicone systems. Thus, in some embodiments, condensation-cure silicone systems can be prepared without the use of tin.

Generally, the compositions of the present disclosure comprise a condensation-cure silicone system and a catalyst comprising a precious metal complexed with an actinic-radiation-displaceable ligand. In some embodiments, the silicone system comprises a hydroxyl-functional polyorganosiloxane and a hydride-functional silane. Generally, the hydride-functional silane comprises at least two, and in some embodiments three or more silicon-bonded hydrogen atoms.

Generally, any known hydroxyl-functional polyorganosiloxane suitable for use in condensation-cure systems can be used in the compositions of the present disclosure, and such materials are well-known and readily obtainable. Exemplary polyorganosiloxanes include poly(dialkylsiloxane) (e.g., poly(dimethylsiloxane)), poly(diarylsiloxane) (e.g., poly(diphenylsiloxane)), poly(alkylarylsiloxane) (e.g., poly(methylphenylsiloxane)) and poly(dialkyldiarylsiloxane) (e.g., poly(dimethyldiphenylsiloxane). Both linear and branched polyorganosiloxanes may be used. In some embodiments, one or more of the organo groups may be halogenated, e.g., fluorinated.

Exemplary hydroxyl-functional polyorganosiloxanes include silanol-terminated polydimethylsiloxanes including, e.g., those available from Gelest, Inc., Morrisville, Pa., including those available under the trade names DMS-S12, -S14, -S15, -S21, -S27, -S31, -S32, -S33, -S35,-S42, -S45, and -S51; and those available from Dow Corning Corporation, Midland, Mich., including those available under the trade names XIAMETER OHX Polymers and 3-0084 Polymer, 3-0113 Polymer, 3-0133 Polymer, 3-0134 Polymer, 3-0135 Polymer, 3-0213 Polymer, and 3-3602 Polymer.

In some embodiments, the composition may comprise an alkoxy-functional polydiorganosiloxane that is converted to a hydroxyl-functional polyorganosiloxane in situ, e.g., upon exposure to water. Exemplary alkoxy-functional polydiorganosiloxanes include DMS-XE ethoxy terminated polydimehyl siloxane and DMS-XM11 methoxy terminated polydimethylsiloxane, available from Gelest, Inc.

Generally, any known hydride-functional silane suitable for use in condensation-cure systems can be used in the compositions of the present disclosure, and such materials are well-known and readily obtainable. Exemplary hydride-functional silanes include those available from Dow Corning Corporation, including those available under the trade name SYL-OFF (e.g., SYL-OFF 7016, 7028, 7048, 7137, 7138, 7367, 7678, 7689, and SL-series crosslinkers), and those available from Gelest, Inc.

As is known by one of ordinary skill in the art, the relative amounts of the hydroxyl-functional polyorganosiloxane(s) and the hydride-functional silane(s) can be selected to obtain a variety of useful compositions. Factors effecting such selections include the specific polyorganosiloxane(s) and silane(s) selected, the relative functionality of the silane(s) compared to the polyorganosiloxane(s), the desired degree of cross-linking and/or chain extension, and the desired final properties including e.g., release force, mechanical properties, cure conditions, percent extractables, and the like. Generally, the relative amounts are selected such that ratio of molar equivalents of hydroxyl functionality to molar equivalents of hydride functionality is between 0.01 and 10, inclusive, e.g., between 0.04 and 2, inclusive.

Generally, the catalysts useful in various embodiments of the present disclosure comprise a precious metal complexed with an actinic-radiation-displaceable ligand. Such catalysts are known to catalyze the hydrosilation reaction leading to the cure of addition-cure silicone systems. However, the present inventors have surprisingly discovered that similar catalysts are effective in catalyzing the reaction of Si—OH and Si—H groups to cure condensation-cure systems.

As used herein, “precious metal” refers to the platinum group elements located in the d-block of the periodic table, more specifically, the six elements located in groups 8, 9, and 10; periods 5 and 6. The six precious metals are ruthenium (Ru), rhodium (Rh), palladium (Pd), osmium(Os), iridium (Ir), and platinum (Pt). In some embodiments, the group 10 precious metals, i.e., palladium and platinum, may be preferred.

As used herein, “radiation-displaceable ligand” refers to a moiety that, when associated with the precious metal inhibits its ability to catalyze the condensation reaction, but, when exposed to actinic radiation, is either displaced or otherwise modified such that the precious metal becomes available to catalyze the reaction. As used herein, “actinic radiation” means photochemically active radiation and particle beams, including, but not limited to, accelerated particles, for example, electron beams; and electromagnetic radiation, for example, microwaves, infrared radiation, visible light, ultraviolet light, X-rays, and gamma-rays. In some embodiments, actinic radiation having a wavelength between 200 and 800 nm, inclusive, may be used; e.g., actinic radiation having a wavelength between 200 and 400 nm, inclusive.

Radiation-displaceable ligands suitable for use in various embodiments of the present disclosure include ligands comprising at least one of a beta-diketonate (β-diketonate), an eta-bonded cyclopentadienyl (η-cyclopentadienyl), and a sigma-bonded aryl (σ-aryl).

Photocatalysts suitable for curing polysiloxane compositions according to the present invention include catalysts effective in initiating or promoting a hydrosilation cure reaction. Such a catalyst is referred to herein as a noble or precious metal photocatalyst or a hydrosilation photocatalyst. Materials of this type include (η-cyclopentadienyl) trialkylplatinum complexes as described in U.S. Pat. No. 4,510,094, (η-diolefin)(σ-aryl)platinum complexes similar to those in U.S. Pat. No. 4,530,879 and β-diketone complexes of palladium (II) or platinum (II), such as platinum acetyl acetonate (U.S. Pat. No. 5,145,886). Preferred precious metal hydrosilation photocatalysts include bisacetylacetonate platinum (II) [Pt(AcAc)2] and (η-cyclopentadienyl)trimethylplatinum [Pt CpMe3]. These hydrosilation photocatalysts, when included in photocurable polysiloxane compositions at concentrations between about 5 ppm and about 100 ppm, remarkably cure sealants applied to polycarbonate slabs in a few seconds.

In some embodiments, the ligand comprises a beta-diketonate. In some embodiments, the diketonate is selected from the group consisting of 2,4-pentanedionates; 2,4-hexanedionates; 2,4-heptanedionates; 3,5-heptanedionates; 1-phenyl-1,3-heptanedionate, 1,3-diphenyl-1,3-propanedionate, and the like. For example, in some embodiments, the diketonate is a 2,4-pentanedionate, e.g., the catalysts may be M-2,4-pentanedionate, where M is platinum or palladium.

In some embodiments, the ligand comprises a cyclopentadienyl. For example, in some embodiments, the catalyst may be an (η-cyclopentadienyl)tri(σ-aliphatic)-M complex, wherein M is a precious metal. In some embodiments, the (η-cyclopentadienyl) tri(σ-aliphatic)-M complex has the formula CpM-(R¹)₃; wherein Cp represents the cyclopentadienyl group that is eta-bonded to the precious metal, and each R¹ group is, independently, is a saturated aliphatic group having one to eighteen carbon atoms sigma bonded to the precious metal. In some embodiments, the cyclopentadienyl group is substituted with at C1 to C4 hydrocarbon. In some embodiments, the catalyst is a trialkyl(cyclopentadienyl)-precious metal complex. In some embodiments, the precious metal is platinum or palladium, e.g., trimethyl(methylcyclopentadienyl)platinum.

In some embodiments, the ligand comprises a cyclooctadienyl. In some embodiments, the catalyst has the formula COD-M-(Aryl)₂; wherein COD is the cyclooctadienyl group, M is a precious metal, and Aryl represents an aryl group. In some embodiments, M is platinum or palladium. In some embodiments, the aryl group is a phenyl group substituted with one or more of an akyl group, an alkoxy group, and a halogen. In some embodiments, at least one of the alkyl groups or alkoxy groups is perfluorinated.

Generally, the amount of catalyst is usually selected based on the desired amount of precious metal based on the total weight of the hydroxyl-functional polyorganosiloxane and the hydride-functional silane. The selected amount may vary depending on, e.g., the specific polyorganosiloxanes and silanes presenting the system, the available source of actinic radiation, e.g., electron beam, UV light, and the like. Generally, the amount of catalyst present will be at least 1 part per million (ppm) precious metal based on the total weight of the hydroxyl-functional polyorganosiloxane and the hydride-functional silane, e.g., at least 5 ppm, or even at least 10 ppm. In some embodiments, the composition comprises 5 to 200 ppm of the precious metal based on the total weight of the hydroxyl-functional polyorganosiloxane and the hydride-functional silane, e.g., 5 to 100 ppm, 10 to 100 ppm, or even 10 to 50 ppm.

### EXAMPLES

Unless otherwise noted, all parts, percentages, ratios, etc., in the examples and in the remainder of the specification are by weight. Unless otherwise noted, all chemicals were obtained from, or are available from, chemical suppliers such as Sigma-Aldrich Chemical Company, St. Louis. Mo.

“Silicone-A” is a 30 weight percent solids dispersion of a blend of 94% reactive hydroxysilyl-functional siloxane polymer(s) (said to comprise hydroxyl-terminated polydimethylsiloxane) and 6% hydrosilyl-functional polysiloxane crosslinker (said to comprise poly(methyl)(hydrogen)siloxane) in xylene (a premium release coating composition obtained from Dow Corning Corporation, Midland, Mich., under the trade designation SYL-OFF 292).

“XLINK-1” is a 100% solids silane crosslinker (said to comprise methylhydrogen cyclosiloxane, obtained from Dow Corning Corporation, Midland, Mich., under trade designation SYL-OFF 7048).

“Silicone-B” is a silanol-terminated organosiloxane, obtained from Dow Corning Corporation under trade designation DOW CORNING 3-0134 POLYMER 50 000 CST.

“Silicone-C” is a silanol-terminated polyorganosiloxane, obtained from Dow Corning Corporation under trade designation DOW CORNING 3-0135 POLYMER.

“Silicone-D” is a silanol-terminated polydimethylsiloxane, obtained from Gelest, Inc., Morrisville, Pa., under trade designation DMS-521.

“Silicone-E” is a silanol-terminated polydimethylsiloxane, obtained from Gelest, Inc. under trade designation “DMS-527”.

“Q-Resin” is a silanol-trimethylsilyl modified Q-resin, obtained from Gelest, Inc. under trade designation SQT-221.

“Silica-A” is a fumed hydrophobic silica nanoparticle powder obtained from Evonik-Degussa Corp., Piscataway, N.J., under trade designation “AEROSILR R805”.

“Pt-Cat-A” was platinum bis(acetylacetonate) (alternatively known as platinum (II)-2,4-pentanedionate or bis(pentane-2,4-dionato-O,O)platinum), purchased from Sigma-Aldrich Chemical Company, St. Louis, Mo. “Pt-Cat-B” was trimethyl(methylcyclopentadienyl)platinum, purchased from Alfa-Aesar, Ward Hill, Mass. “Pd-Cat” was palladium bis(acetylacetonate), purchased from Sigma-Aldrich Chemical Company. The catalysts were kept in the dark before use.

Coat Weight Procedure. Coat weights were determined by punching about 2.54 cm diameter samples of coated and uncoated substrates and comparing the weight difference using an EDXRF spectrophotometer (obtained from Oxford Instruments, Elk Grove Village, Ill. under trade designation OXFORD LAB X3000).

Extractables Procedure. Unreacted silicone extractables were measured on cured thin film formulations to ascertain the extent of silicone crosslinking. The coat weight of a 2.54 cm diameter of coated substrate sample was determined according to the Coat Weight Procedure. The coated substrate sample was then dipped in and shaken in methyl isobutyl ketone (MIBK) for 5 minutes, removed, and allowed to dry. The silicone coating weight was measured again according to the Coat Weight Procedure. Silicone extractables (i.e., extent of silicone crosslinking) were attributed to the weight difference between the silicone coat weight before and after treatment in MIBK as a percent.

NMR Procedure. 29Si NMR analysis was performed on bulk cured silicone formulations (i.e. RTV formulations) to measure the degree of crosslinking and to verify the chemical species in the cured product. To analyze the 29Si NMR spectra of the cured products (i.e., solids), the cured products were packed into 4 mm rotors. Spectra were collected using a Varian NMRS 400 MHz NMR Spectrometer equipped with a Varian 4 mm HXY MAS probe at 8 kHz of MAS and 25° C. (obtained from Agilent Technologies, Santa Clara, Calif.). Single pulse excitation was used with a pulse width of 2.5 microseconds (us), a 60 second recycle delay, 500 ms of acquisition and 25 kHz of 1H decoupling.

Examples 1 to 6 exemplify condensation-cure, silicone RTVs and were prepared by mixing a silanol functional organosiloxane, a hydride-functional silane crosslinker, and a catalyst, with optional additives, as summarized in Table 1. The samples were cured by applying a small amount of the mixture to a glass substrate (about 15 cm by 4.5 cm, borosilicate glass microscope slides) and exposing it to UV irradiation from a UV lamp equipped with two UV bulbs (intensity peak at 254 nm, UV Lamp Length: about 46 cm, 15-watt, obtained from Philips Electronics N.V., Netherlands, under trade designation “PHILIPS TUV G15T8 GERMICIDAL UV BULB”) positioned 2.0 cm above samples. Rapid reaction set-in after a latent period of 40-45 seconds with rapid evolution of hydrogen gas leading to hardening of the formulation within 10 minutes. The occurrence and completion of the cure reaction were confirmed using the NMR Procedure.

TABLE 1
Sample compositions.

| | Silicone | | XLINK-1 | Pd-Cat¹ | | Other | |
|---|---|---|---|---|---|---|---|
| Ex. | Type | (g) | (g) | (g) | ppm² | Descr. | (g) |
| 1 | B | 8.5 | 1.5 | 0.05 | 35 | none | — |
| 2 | B | 8.5 | 1.5 | 0.025 | 17.5 | Silica-A | 0.3 |
| 3 | E | 8.5 | 1.5 | 0.025 | 17.5 | none | — |
| 4 | E | 8.5 | 1.5 | 0.025 | 17.5 | Q-Resin | 0.3 |
| 5 | C | 8.5 | 1.5 | 0.025 | 17.5 | none | — |
| 6 | C | 8.5 | 1.5 | 0.025 | 17.5 | Silica | 0.3 |

¹2.0 wt. % solution in dichloromethane
²ppm precious metal based on total weight of silanol-functional organosiloxane (Silicone) and hydride functional silane (XLINK-1)

Example 7 exemplifies a condensation-cure, silicone release material prepared as follows. Silicone-A (3.0 g) was diluted with 12 g heptanes followed by the addition of 149 ppm platinum based on the total weight of Silicone-A (Pt-Cat-A: 0.045 g, 2 wt % solution in methyl ethyl ketone). The formulation was mixed thoroughly and then coated on 58# Poly Coated Kraft (PCK) paper (obtained from Jen Coat Inc., Westfield, Mass.) with a #4 Mayer bar. The curing of the coated layer was performed at room temperature using 254 nm UV irradiation, as described above for Example 1, for 15 minutes. The cured release liner coating showed no smear upon rubbing with fingers. The silicone extractables were determined immediately after coating according to the Extractables Procedure and were found to be 3.9 weight %.

Example 8 formulation was prepared by mixing Silicone-D silanol terminated organosiloxane (9.62 g), XLINK-1 silane crosslinker (0.39 g), and 35 ppm platinum based on the combined weight of Silicone-D and XLINK-1 (0.05 g Pt-Cat-A; 2 wt % solution in dichloromethane). The formulation was prepared in an amber bottle and precautions were taken to minimize the photo-exposure. The formulation was mixed thoroughly and was coated on 58# Poly Coated Kraft (PCK) paper with a #4 Mayer bar. To activate the catalyst, the coatings were passed through the “LIGHT HAMMER 6” UV-chamber (obtained from Fusion UV Systems, Inc. Gaithersburg, Md., under trade designation “Light HammerR 6”) equipped with an H-bulb located at 5.3 cm above sample at 11 meters/minute, followed by heating at 110° C. for 60 seconds leading to adherent thin films. Generally, H-bulbs emit light over a spectrum of wavelengths with relevant intensity peaks between 250 and 365 nm. The silicone extractables were determined immediately after coating as described above and were found to be 8 wt. %.

Example 9 was prepared by mixing Silicone-E silanol terminated organosiloxane (9.62 g), XLINK-1 silane crosslinker (0.39 g), and 35 ppm platinum (0.05 g Pt-Cat-A; 2 wt % solution in dichloromethane). The formulation was mixed thoroughly and coated on 58# PCK paper with a #4 Mayer bar. The curing of the coated layer was performed as described above for Example 8. The silicone extractables were determined immediately after coating as described above and were found to be 4.2 wt. %.

Example 10 was prepared by mixing Silicone-E silanol terminated organosiloxane (9.62 g), XLINK-1 silane crosslinker (0.39 g), and 30.5 ppm platinum (0.005 g Pt-Cat-B). The formulation was prepared in an amber bottle and precautions were taken to minimize the photo-exposure. The formulation was mixed thoroughly and was coated on 58# PCK paper with a #4 Mayer bar. The curing of the coated layer was performed as described above for Example 8. The silicone extractables were determined immediately after coating as described above and were found to be 15 wt. %.

Examples 11-16 exemplify condensation-cure, silicone RTVs prepared by mixing a silanol terminated organosiloxane, a hydride-functional silane crosslinker, a catalyst and optional additives, as summarized in Table 2. The formulations were cured by exposure to 254 nanometer (nm) UV irradiation from a distance of 1.0 cm with a hand-held compact UV lamp “UVGL-25” (obtained from UVP, LLC., Upland, Calif.) equipped with a 4-Watt, 0.16 Ampere UV bulb. Rapid reaction set-in after a latent period of 40-45 seconds accompanied by rapid evolution of gas (H₂) leading to hardening of the formulation within five minutes.

The Example 17 was prepared by mixing Silicone-B silanol terminated organosiloxane (8.5 g), XLINK-1 silane crosslinker (1.5 g), and Pt-Cat-B (0.005 g). The sample was cured as described for Example 1. Rapid reaction set-in after a latent period of 40-45 seconds with rapid evolution of hydrogen gas leading to hardening of the formulation within 10 minutes.

TABLE 2
Sample compositions.

| | Silicone | | XLINK-1 | Catalyst | | | Other | |
|---|---|---|---|---|---|---|---|---|
| Ex. | Type | (g) | (g) | I.D. | (g) | ppm¹ | Descr. | (g) |
| 11 | C | 8.5 | 1.5 | Pt-Cat-A² | 0.025 | 17.5 | none | — |
| 12 | C | 8.5 | 1.5 | Pt-Cat-A | 0.025 | 17.5 | Silica | 0.3 |
| 13 | E | 8.5 | 1.5 | Pt-Cat-A | 0.025 | 17.5 | Silica | 0.3 |
| 14 | E | 8.5 | 1.5 | Pt-Cat-A | 0.025 | 17.5 | Q-resin | 0.3 |
| 15 | B | 8.5 | 1.5 | Pt-Cat-A | 0.025 | 17.5 | none | — |
| 16 | B | 8.5 | 1.5 | Pt-Cat-A | 0.025 | 17.5 | Silica | 0.3 |
| 17 | B | 8.5 | 1.5 | Pt-Cat-B | 0.005 | 30.5 | none | — |

¹ppm precious metal based on total weight of silanol-functional organosiloxane (Silicone) and hydride functional silane (XLINK-1)
²2 wt % solution in dichloromethane

Example 18 was prepared in the same manner as Example 11, except the formulation was hardened (i.e., cross-linked) by exposing the coating to visible room lights for 4 hours.

Various modifications and alterations of this invention will become apparent to those skilled in the art without departing from the scope and spirit of this invention.

1. A curable composition comprising:
(a) a hydroxyl-functional polyorganosiloxane;
(b) a hydride-functional silane comprising at least two silicon-bonded hydrogen atoms; and
(c) a catalyst comprising a precious metal complexed with an actinic-radiation-displaceable ligand.

2. The curable composition of claim 1, wherein the precious metal is platinum or palladium.

3. The curable composition of claim 1, wherein the ligand is displaceable upon exposure to actinic radiation having a wavelength of 200 to 800 nm, inclusive.

4. The curable composition of claim 3, wherein the ligand is displaceable upon exposure to actinic radiation having a wavelength of 200 to 400 nm, inclusive.

5. The curable composition according to claim 1, wherein the ligand comprises at least one of a beta-diketonate, an eta-bonded cyclopentadienyl, and a sigma-bonded aryl.

6. The curable composition of claim 5, wherein the ligand comprises a beta-diketonate.

7. The curable composition of claim 6, wherein the diketonate is selected from the group consisting of 2,4-pentanedionates; 2,4-hexanedionates; 2,4-heptanedionates; 3,5-heptanedionates; 1-phenyl-1,3-heptanedionate; and 1,3-diphenyl-1,3-propanedionate.

8. The curable composition of claim 7, wherein the diketonate is a 2,4-pentanedionate.

9. The curable composition of claim 8, wherein the catalyst is M-2,4-pentanedionate, where M is platinum or palladium.

10. The curable composition of claim 5, wherein the ligand comprises a cyclopentadienyl.

11. The curable composition of claim 10, wherein the catalyst is an (η-cyclopentadienyl)tri(σ-aliphatic)-M complex, wherein M is a precious metal.

12. The curable composition of claim 11, wherein the (η-cyclopentadienyl)tri(σ-aliphatic)-M complex has the formula
CpM-(R¹)₃;
wherein Cp represents the cyclopentadienyl group that is eta-bonded to the precious metal, and each R¹ group is, independently, is a saturated aliphatic group having one to eighteen carbon atoms sigma bonded to the precious metal.

13. The curable composition of claim 11, wherein the cyclopentadienyl group is substituted with at C1 to C4 hydrocarbon.

14. The curable composition of claim 13, wherein the catalyst is a trimethyl(cyclopentadienyl)-precious metal complex, wherein the precious metal is platinum or palladium.

15. The curable composition of claim 14, wherein the catalyst is selected from the group consisting of trimethyl(methylcyclopentadienyl)platinum and trimethyl(cyclopentadienyl)platinum.

16. The curable composition of claim 5, wherein the ligand comprises a cyclooctadienyl.

17. The curable composition of claim 16, wherein the catalyst has the formula
COD-M-(Aryl)₂;
wherein COD is the cyclooctadienyl group, M is a precious metal, and Aryl represents an aryl group.

18. The curable composition of claim 17, wherein M is platinum or palladium.

19. The curable composition of claim 17, wherein the aryl group is a phenyl group substituted with one or more of an alkyl group, an alkoxy group, and a halogen.

20. The curable composition of claim 19, wherein at least one of the alkyl groups or alkoxy groups is perfluorinated.

21. The curable composition according to claim 1, wherein the composition comprises 5 to 200 ppm of the precious metal based on the total weight of the hydroxyl-functional polyorganosiloxane and the hydride-functional silane.

22. A method of preparing a cured composition comprising, exposing the curable composition of claim 1 to actinic radiation, and condensation-curing the hydroxyl-functional polyorganosiloxane with the hydride-functional silane to form the cured composition.

23-27. (canceled)
